(19) United States
(12) Patent Application Publication
(10) Pub. No.: US 2026/0145183 A1
(43) Pub. Date: May 28, 2026

(54) INERTING SYSTEM

(71) Applicant: Airbus Operations Limited, FILTON (GB)

(72) Inventor: Henry EDWARDS, FILTON (GB)

(21) Appl. No.: 19/388,206

(22) Filed: Nov. 13, 2025

(30) Foreign Application Priority Data
Nov. 28, 2024 (GB) 2417513.5

(51) Int. Cl. B04C 11/00; B04C 3/00; B64D 37/32

(52) U.S. Cl. CPC B04C 11/00; B04C 3/00; B64D 37/32

(57) ABSTRACT

An inerting system is provided with a vortex tube for separating air into nitrogen enriched air (NEA) and oxygen enriched air (OEA). The inerting system has a warming device which warms NEA as it flows between an NEA outlet of the vortex tube and an NEA port of the inerting system. A method is also provided of supplying conditioned NEA to an enclosure, in which air is centrifugally separated into NEA and OEA in a vortex tube and the NEA is warmed so as to produce the conditioned NEA.

### CROSS-REFERENCES TO RELATED APPLICATIONS

This application claims the benefit of United Kingdom Patent Application Number 2417513.5 filed on Nov. 28, 2024, the entire disclosures of which are incorporated herein by way of reference.

### FIELD OF THE INVENTION

The present disclosure relates to the field of vortex tubes for aircraft enclosure inerting systems. It relates particularly, but not exclusively, to vortex tubes for inerting systems which can be used to fill the ullage of an aircraft fuel tank with nitrogen enriched air as a fire safety precaution.

### BACKGROUND OF THE INVENTION

Owing to airworthiness requirements, most commercial aircraft require the use of fuel tank inerting systems among a suite of other measures to prevent aircraft fuel tank fires or explosions. The primary purpose of such inerting systems (also referred to as inert gas generation systems) is to reduce the oxygen (O₂) concentration within the aircraft fuel tank ullage, and hence the ullage flammability, thereby preventing the ability of the ullage to combust. State of the art systems comprise the use of one or more Air Separation Modules (ASMs) to separate bleed air into nitrogen enriched air (NEA), sometimes called oxygen depleted air, and oxygen enriched air (OEA). The OEA is exhausted overboard from the aircraft while the NEA is fed in a controlled manner at predetermined rates into the ullage above the fuel in the aircraft's fuel tank or tanks such that the O₂ concentration of the ullage is kept below an upper limit (for instance 12%) during most operating conditions of the aircraft.

In conventional systems bleed air, which is high temperature and pressure air bled from an engine or from a separate compressor fed by a ram air channel, is filtered and cooled before being inputted into the ASM(s). Cooling and filtering of the bleed air is important because the ASM contains a membrane, often in the form of a set of hollow fibers, over which the input air passes. The membrane can be clogged if the input air contains contaminants like dust, and degrades too rapidly if subjected to input air above a certain temperature. The membrane of the/each ASM is permeable to oxygen but not to nitrogen, so as the air passes over the membrane much of the oxygen it contains passes through the membrane while the nitrogen continues along it. This separates the air into the NEA and OEA. The NEA can then be regulated into the ullage, while the OEA can be discarded as mentioned.

An alternative way of producing NEA is through use of a vortex tube. A vortex tube has a vortex chamber into which air is formed into a vortex. As the air rotates inside the chamber it produces a hotter stream around the outside and a colder stream towards the middle. Vortex tubes are generally used to provide cooling rather than air separation. However, oxygen, being denser than nitrogen, tends to be thrown out into the outer stream, leaving the inner stream in a nitrogen enriched state. Thus, the cold stream is NEA and the hot stream is OEA.

When used in inerting systems, the temperature difference created by a vortex tube can be problematic. On the one hand, the low temperature of the NEA can cause problems for components that it passes nearby, for instance thickening or freezing liquid in nearby conduits and/or stiffening sealing gaskets. Also, the low temperature of the NEA can cause water in ambient air to condense (and potentially freeze) on a duct along which the NEA passes and/or a storage vessel in which it is held. On the other hand, the high temperature of the OEA can cause problems, for instance burning or melting components near to a duct along which it passes and/or a storage vessel in which it is held.

The present invention seeks to mitigate one or more of the above-mentioned problems. Instead or as well, the present invention seeks to provide an improved or alternative inerting system, aircraft, or method of supplying a conditioned NEA flow to an enclosure.

### SUMMARY OF THE INVENTION

According to a first aspect of the present invention, there is provided an inerting system configured to separate an inlet air flow into nitrogen enriched air (NEA) and oxygen enriched air (OEA), the inerting system having a vortex tube comprising:
an inlet configured to receive the inlet air flow from an inlet port of the inerting system;
a vortex chamber configured to receive the inlet air flow from the inlet and centrifugally separate it into the NEA and the OEA;
an NEA outlet configured to exhaust the NEA towards an NEA port of the inerting system; and
an OEA outlet configured to exhaust the OEA towards an OEA port of the inerting system,
wherein the inerting system further comprises a warming device configured to warm the NEA as it passes from the NEA outlet of the vortex tube to the NEA port of the inerting system.

With the warming device warming the NEA, the above problems which may be caused by the NEA having a low temperature (namely the freezing or thickening of nearby liquids, stiffening of sealing gaskets and/or causing water in ambient air to condense or freeze) may be diminished or eliminated. The NEA being warmed between the NEA outlet of the vortex tube and the NEA port of the inerting system, rather than somewhere downstream of the NEA port, may mean that there is less opportunity for cold NEA to cause problems while flowing to the point at which it is warmed.

The inlet port, OEA port and/or the NEA port of the inerting system may comprise connection features configured for engagement with complementary connection features of air ducts, e.g., of an aircraft. As an alternative, one or more of the inlet port, OEA port and NEA port may be a simple aperture such as an end of a pipe of a hole in an outer casing.

The warming device may be configured to warm the NEA while the NEA is flowing between the NEA outlet and the NEA port, for instance while it moves along a duct. Instead or as well, the warming device may be configured to warm the NEA in a storage vessel which is positioned between the NEA outlet and the NEA port.

The warming device may comprise a heat exchanger configured to transfer heat from the OEA to the NEA without mixing the OEA and NEA.

By transferring heat from the OEA, the system may make use of “waste heat” in warming the NEA and thereby exhibit improved power consumption, while avoiding mixing the OEA and NEA maintains the low oxygen levels of the NEA.

Instead or as well, the warming device may comprise a heater such as an electrical heating element, and/or a heat exchanger configured to transfer heat into the NEA from an auxiliary source such as an engine coolant system.

In the heat exchanger, the OEA may partially or substantially entirely surround the NEA.

This may space the (still cold) NEA away from other components such as fluid ducts, or ambient air from which moisture may condense, so as to reduce the negative impact the NEA can have before it has been fully warmed.

Where the OEA partially surrounds the NEA within the heat exchanger, the OEA may extend around the NEA by an angle of at least 90 degrees, for instance at least 180 degrees or at least 270 degrees.

As an alternative, within the heat exchanger the NEA may partially or entirely surround the OEA. This may be beneficial where the potential harm which could be caused by the (hot) OEA is larger than that which could be caused by the (cold) NEA. As another alternative, in the heat exchanger the OEA and NEA may be positioned next to one another.

The heat exchanger may be a shell and tube heat exchanger.

Such a heat exchanger may offer beneficially swift heat transfer from the OEA to the NEA, thereby requiring the NEA to spend a relatively short time in the heat exchanger.

Where further definition is needed, a shell and tube heat exchanger may be considered to be a heat exchanger in which one fluid passes through a vessel and the other fluid passes through a plurality of pipes which extend within the vessel.

The heat exchanger may be a double pipe heat exchanger.

Such a heat exchanger may be beneficially compact and/or low cost, thereby allowing the inerting system to be similarly compact and/or low cost. Instead or as well, it may allow the NEA to take a beneficially straight path between the NEA outlet and the NEA port, which may reduce flow losses in the NEA and thus leave the NEA with more energy available for use downstream.

Where further definition is needed, a double pipe heat exchanger may be considered to be a heat exchanger in which one fluid passes through a larger diameter duct and the other fluid passes through a smaller diameter duct which extends along and within the larger diameter duct. The smaller diameter duct may be positioned substantially concentrically within the larger diameter duct, but in some cases the smaller diameter duct may extend along the larger diameter duct at a slight angle and/or may be positioned slightly off-center within the larger diameter duct.

As one alternative, the heat exchanger may be a plate heat exchanger.

The heat exchanger may be a parallel-flow heat exchanger.

This may be beneficial in that the NEA and OEA can travel to and/or from such a heat exchanger through a flow path which is beneficially simple and/or short, which may minimize flow losses in the NEA and/or OEA.

It is to be understood that in a parallel-flow heat exchanger the NEA and OEA may not necessarily travel precisely parallel to one another. Instead or as well, it is to be understood that the NEA and/or the OEA may run in markedly different directions to parallel when entering and/or exiting a parallel-flow heat exchanger.

The heat exchanger may be a counter-flow heat exchanger.

This may allow more heat to be transferred from the OEA to the NEA for a given size of heat exchanger, thereby allowing the NEA to be heated to a higher temperature, heated more quickly, and/or heated in a beneficially compact heat exchanger.

It is to be understood that in a counter-flow heat exchanger the NEA and OEA may not necessarily travel precisely antiparallel to one another. Instead or as well, it is to be understood that the NEA and/or the OEA may run in markedly different directions to antiparallel when entering and/or exiting a counter-flow heat exchanger.

The heat exchanger may be a cross-flow heat exchanger.

Such a heat exchanger may offer a beneficial compromise between simplicity/shortness of path for the NEA and OEA to and/or from the heat exchanger (as per a parallel-flow heat exchanger) and amount of heat transferred (as per a counter-flow heat exchanger).

It is to be understood that in a cross-flow heat exchanger the NEA and OEA may not necessarily travel precisely perpendicularly to one another. Instead or as well, it is to be understood that the NEA and/or the OEA may run in markedly different directions to perpendicular when entering and/or exiting a cross-flow heat exchanger.

The inerting system may further comprise an NEA duct arrangement configured to convey the NEA from the NEA outlet of the vortex tube to the NEA port of the inerting system along a generally straight flow path.

This may allow the NEA to travel from the NEA outlet to the NEA port with beneficially few flow losses due to changes in flow path direction.

Where further definition is needed, a generally straight flow path may be considered to be a flow path which bends through a total of less than 90 degrees, for instance less than 60 degrees or less than 30 degrees.

The inerting system may further comprise a controller operably coupled to the warming device and configured to selectively activate and deactivate the warming device.

For example, where the NEA is warmed in a heat exchanger the controller may selectively re-route the NEA and/or OEA through flow paths which bypass the heat exchanger. As another example where the NEA is warmed by an electrical heater, the controller may selectively power the electrical heater on or off.

As an alternative, the inerting system may be configured whereby heating of the NEA takes place whenever the system is in operation.

The inerting system may be an aircraft enclosure inerting system.

One or more of the problems associated with the temperature of the NEA and/or the OEA may pose particular problems in aviation, therefore one or more of the advantages discussed above may be of particular benefit.

According to a second aspect of the invention there is provided an aircraft comprising an aircraft enclosure inerting system according to the first aspect of the invention.

With the enclosure inerting system reducing the risk posed by the temperatures of the NEA and/or OEA, there may be fewer constraints placed on the locations of other components of the aircraft relative to the enclosure inerting system. This improved design freedom may improve the performance of the aircraft, for instance its aerodynamics and/or ease of manufacture or maintenance.

The inerting system may further comprise one or more additional vortex tubes. The vortex tube and the additional vortex tube(s) may be connected in series (with the NEA produced by the most upstream vortex tube being further refined by the vortex tube(s) downstream of it) and/or in parallel (with each vortex tube receiving a portion of the inlet air flow and producing a portion of the NEA and OEA).

According to a third aspect of the present invention there is provided a method of supplying conditioned nitrogen enriched air (NEA) to an enclosure, the method comprising:
providing an inlet air flow to a vortex tube;
centrifugally separating the inlet air flow into NEA and oxygen enriched air (OEA) in the vortex tube;
warming the NEA to produce conditioned NEA; then
supplying the conditioned NEA to the enclosure.

By supplying conditioned NEA, which has been warmed, the above problems that can be caused by the NEA having a low temperature (namely the freezing or thickening of nearby liquids, stiffening of sealing gaskets and causing water in ambient air to condense or freeze) may be diminished or eliminated.

The method may be performed as a continuous process (i.e., with the inlet air flow being provided while previous inlet air is being separated, and with conditioned NEA being supplied while fresh NEA is being warmed). As an alternative, the method may be performed batchwise. For example, the method may comprise producing and storing a quantity of NEA before then ceasing production of NEA and warming the NEA that has been stored.

The NEA may be warmed by transferring heat from the OEA to the NEA without mixing them.

By transferring heat from the OEA, the method may make use of “waste heat” in warming the NEA and may thereby be performed at a beneficially low level of power consumption. Not mixing the OEA and NEA can ensure that the low oxygen content of the NEA is unaffected by warming it.

Instead or as well, the NEA may be warmed using a heater such as an electrical heating element, and/or by transferring heat into the NEA from an auxiliary source such as an engine coolant system.

Heat may be transferred from the OEA to the NEA while the OEA partially or entirely surrounds the NEA.

This may space the (still cold) NEA away from other components such as fluid ducts, or ambient air from which moisture may condense, so as to reduce the negative impact the NEA can have before it has been fully heated.

Where the OEA partially surrounds the NEA, the OEA may extend around the NEA by an angle of at least 90 degrees, for instance at least 180 degrees or at least 270 degrees.

As an alternative, heat may be transferred from the OEA to the NEA while the NEA partially or entirely surrounds the OEA. This may be beneficial where the potential harm which could be caused by the (hot) OEA is larger than that which could be caused by the (cold) NEA. As another alternative, heat may be transferred from the OEA to the NEA while the NEA and OEA are positioned next to one another.

Heat may be transferred from the OEA to the NEA by passing the OEA and NEA through a shell and tube heat exchanger.

This may warm the NEA to sufficient temperature beneficially rapidly, in comparison to other layouts of heat exchanger.

Where further definition is needed, a shell and tube heat exchanger may be considered to be a heat exchanger in which one fluid passes through a vessel and the other fluid passes through a plurality of pipes which extend through said vessel.

Heat may be transferred from the OEA to the NEA by passing the OEA and NEA through a double-pipe heat exchanger.

This may allow the NEA to be warmed using a heat exchanger which is beneficially compact and/or low cost. Instead or as well, it may allow the NEA to take a beneficially straight path between the NEA outlet and the NEA port, which may reduce flow losses in the NEA.

Where further definition is needed, a double pipe heat exchanger may be considered to be a heat exchanger in which one fluid passes through a larger diameter duct and the other fluid passes through a smaller diameter duct which extends along and within the larger diameter duct. The smaller diameter duct may be positioned substantially concentrically within the larger diameter duct, but in some cases the smaller diameter duct may extend along the larger diameter duct at a slight angle and/or may be positioned slightly off-center within the larger diameter duct.

As one alternative, heat may be transferred from the OEA to the NEA by passing the OEA and NEA through a plate heat exchanger.

The OEA and NEA may pass in generally parallel directions while heat is being transferred from the OEA to the NEA.

This may be beneficial in that the NEA and OEA can be directed to flow in parallel directions with advantageously few bends in their respective flow paths (for instance with either the NEA or the OEA bending through around 180 degrees, or with the NEA and OEA each bending through around 90 degrees), which may reduce flow losses in the NEA and/or OEA.

It is to be understood that the NEA and OEA may not necessarily travel precisely parallel to one another within the heat exchanger. Instead or as well, it is to be understood that the NEA and/or the OEA may run in markedly different directions to parallel when entering and/or exiting the heat exchanger.

The OEA and NEA may pass in generally antiparallel directions while heat is being transferred from the OEA to the NEA.

This may allow more heat to be transferred from the OEA to the NEA for a given size of heat exchanger, thereby allowing the NEA to be heated to a higher temperature, heated more quickly, and/or heated in a beneficially compact heat exchanger.

It is to be understood that the NEA and OEA may not necessarily travel precisely antiparallel to one another within the heat exchanger. Instead or as well, it is to be understood that the NEA and/or the OEA may run in markedly different directions to antiparallel when entering and/or exiting the heat exchanger.

The OEA and NEA may pass generally transverse to one another while heat is being transferred from the OEA to the NEA.

This may offer a beneficial compromise between the straightness of paths for the NEA and OEA to follow to the heat exchanger (as per them flowing parallel to one another) and the amount of heat transferred (as per them flowing antiparallel).

It is to be understood the NEA and OEA may not necessarily travel precisely perpendicularly to one another within the heat exchanger. Instead or as well, it is to be understood that the NEA and/or the OEA may run in markedly different directions to perpendicular when entering and/or exiting the heat exchanger.

The NEA may exit the vortex tube in an outlet direction, and continue to flow generally in the outlet direction at least until it has been warmed.

This may allow the conditioned NEA to be produced with beneficially few flow losses from changes in direction having taken place.

Where further definition is needed, the NEA may be considered to flow generally in the outlet direction if it changes direction by less than 90 degrees, for instance less than 60 degrees or less than 30 degrees.

The method may comprise selectively heating the NEA to produce the conditioned NEA, and at other times supplying the NEA to the enclosure without heating it.

Thus, the enclosure may be supplied with conditioned NEA only when it needs it, with un-conditioned NEA being supplied where this is acceptable. For sake of example the NEA may be warmed if it falls below a predetermined temperature, and supplied to the enclosure without warming if it is above that temperature. This may improve the energy efficiency of the method in total, for instance by only introducing flow losses from a heat exchanger or consuming power using an electrical heater, where this is necessary.

For example, supplying the NEA to the enclosure without heating it may comprise bypassing a heat exchanger or powering off an electrical heater.

As an alternative, the method may comprise warming all NEA produced so as to supply only conditioned NEA to the enclosure.

The enclosure may be an enclosure of an aircraft.

One or more of the problems associated with the temperature of the NEA and/or the OEA may pose particular problems in aviation, therefore one or more of the advantages discussed above may be of particular benefit in this context.

The method may use the inerting system of the first aspect of the invention.

It will of course be appreciated that features described in relation to one aspect of the present invention may be incorporated into other aspects of the present invention.

### BRIEF DESCRIPTION OF THE DRAWINGS

Embodiments of the present invention will now be described by way of example only with reference to the accompanying schematic drawings of which:

FIG. 1 shows a plan view of an aircraft according to a first embodiment of the invention;

FIG. 2 shows a simplified cross-sectional side view of a vortex tube of an enclosure inerting system of the aircraft of FIG. 1;

FIG. 3 shows a simplified cross-sectional end view of the vortex tube of FIG. 2;

FIG. 4 shows a schematic of an inerting system of the aircraft of FIG. 1, which includes the vortex tube of FIGS. 2 and 3;

FIG. 5 shows a flow chart of a method according to the first embodiment of the invention;

FIG. 6 shows a schematic of an inerting system or an aircraft according to a second embodiment of the invention; and

FIG. 7 shows a schematic of an inerting system or an aircraft according to a third embodiment of the invention.

### DETAILED DESCRIPTION OF THE PREFERRED EMBODIMENTS

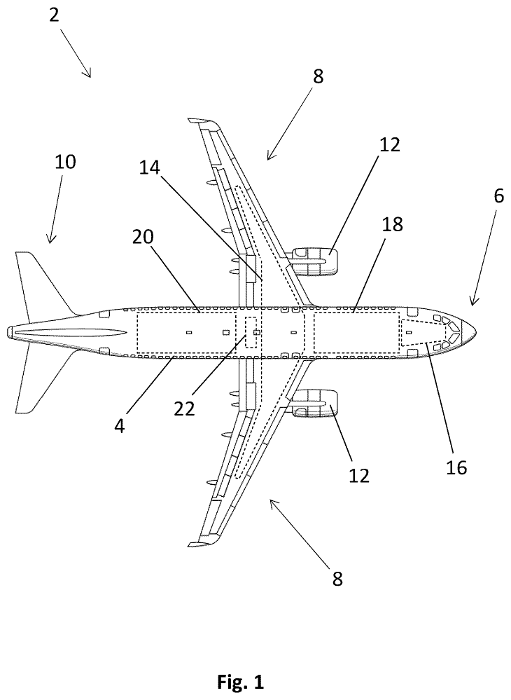

FIG. 1 shows an aircraft 2 according to a first embodiment of the invention. It has a fuselage 4 with a nose 6, two wings 8 and a tail 10. Each wing 8 extends from the fuselage 4 in a spanwise direction and supports an engine 12 part way along its spanwise length. An enclosure in the form of a fuel tank 14 extends inside the wings 8 and through the fuselage 4 therebetween. Behind the nose 6, roughly beneath the cockpit, is another enclosure 16 which, in this case, contains some of the power electronics of the aircraft. Also positioned within the fuselage is a cargo bay made up of a fore enclosure 18 and an aft enclosure 20. The aircraft 2 also has an enclosure inerting system 22 which is arranged to provide nitrogen enriched air (NEA) to each of the enclosures 14, 16, 18, 20 as discussed below.

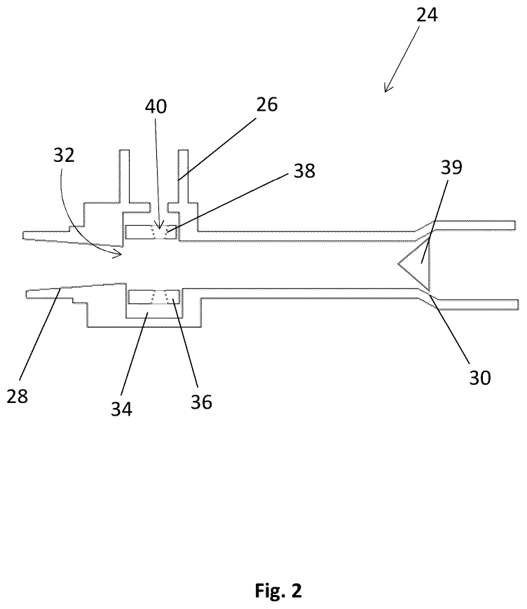

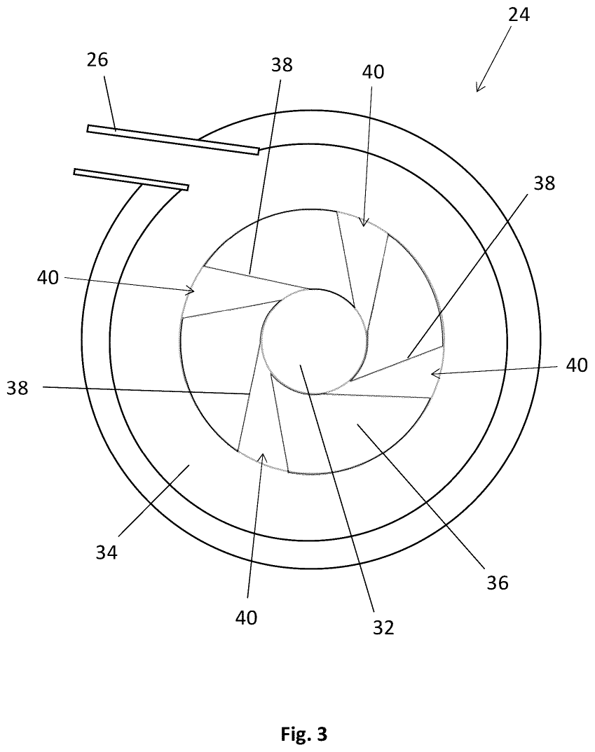

The inerting system 22 receives an inlet air flow from a ram air channel (not visible), then pressurizes it using a compressor (not visible) before cooling it using a heat exchanger (not visible) which brings the temperature of the compressed air down to a manageable level. The inerting system 22 separates the inlet air flow into NEA, which is supplied to the enclosures 14, 16, 18, 20 as needed, and OEA which is exhausted overboard. This separation of air takes place centrifugally, in a vortex tube. The vortex tube is shown schematically in FIGS. 2 and 3, which will now be referred to in combination with FIG. 1.

The vortex tube 24 has an inlet 26, an NEA outlet 28 and an oxygen enriched air (OEA) outlet 30. The vortex tube 24 defines a vortex chamber 32, which is circumferentially surrounded by a plenum chamber 34 fed from the inlet 26. Positioned concentrically between the plenum chamber 34 and the vortex chamber 32, and separating the plenum chamber 34 from the vortex chamber 32 from each other, is a swirl generator 36. The swirl generator 36 has a set of four inlet passages 38 extending therethrough, positioned circumferentially around the vortex chamber 32 at intervals of 90 degrees. The inlet passages 38 provide respective flow paths 40 through which air can flow from the plenum chamber 34 into the vortex chamber 32. In this embodiment the inlet passages 38 take the form of tangential inlets which impart swirl into air flow entering the vortex chamber 32.

The NEA outlet 28 takes the form of a gradually widening aperture extending away from the vortex chamber 32 in one axial direction. The OEA outlet 30 takes the form of an annular passageway positioned circumferentially around a conical projection 39 and extending away from the vortex chamber 32 in the opposite axial direction to the NEA outlet.

In use, the inlet air flow enters the plenum chamber 34 through the inlet 26. The inlet air flow then enters the vortex chamber 32 tangentially through the inlet passages 38 of the swirl generator 36. The inlet passages 38 narrow towards the vortex chamber 32, which accelerates the air passing through them, and introduces the air into the vortex chamber 32 tangentially so as to impart swirl as mentioned above. As the air swirls within the vortex chamber 32, it separates into an outer vortex travelling helically in one direction (to the right from the perspective of FIG. 2) and an inner vortex travelling in the other direction (to the left from the perspective of FIG. 2), with both vortices rotating in the same direction.

The rotation of the air in the two vortices has the effect of throwing the heavier gasses outwards into the outer vortex, with lighter gasses remaining in (or being displaced into) the inner vortex. With oxygen being heavier than nitrogen, the oxygen tends to be thrown out into the outer vortex while the nitrogen tends to remain in the inner vortex. Accordingly, the inner vortex is made up of NEA and the outer vortex is made up of OEA. The NEA forming the inner vortex exits the vortex chamber 32 through the NEA outlet 28, whereupon, in this embodiment, it is fed to a storage tank (not shown) of the inerting system 22 for onward distribution to the enclosures 14, 16, 18, 20 as needed. The OEA forming the outer vortex exits the vortex chamber 32 through the OEA outlet 30, whereupon it is directed towards an exhaust port (not shown) of the inerting system 22 (and of the aircraft as a whole).

Heavier gasses being thrown out from the inner vortex and into the outer vortex also has the effect of expanding the air in the inner vortex and compressing the air in the outer vortex. This has the effect of cooling the NEA in the inner vortex and heating the OEA in the outer vortex.

In this particular embodiment, the position of the conical projection 39 is movable axially so as to vary the cross sectional area of the OEA outlet 30. Changing the cross sectional area of the OEA outlet 30 has the effect of altering the proportion of air which exits through that outlet 30 rather than the NEA outlet 28, which affects the relative sizes of the inner and outer vortices. This, in turn, affects the degree of air separation performed by the vortex tube 24 and the flow rates of OEA and NEA produced. The conical projection 39 therefore functions as a calibration valve which can be adjusted during manufacture of the aircraft (or during routine servicing).

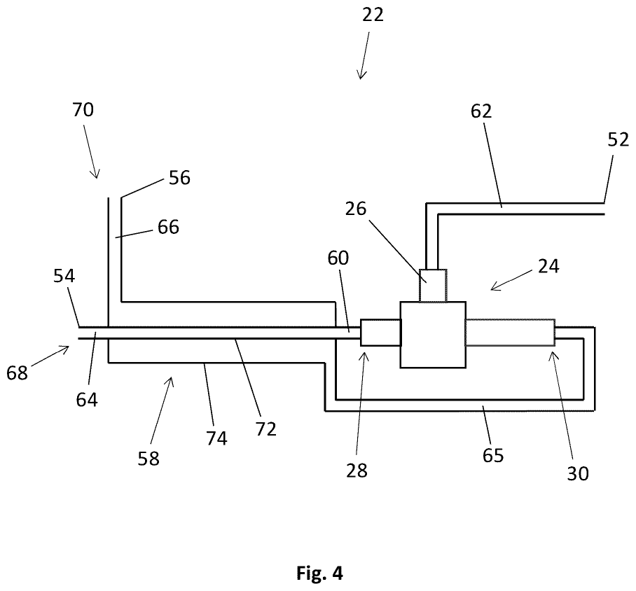

FIG. 4 shows the complete inerting system 22 of the present embodiment. As well as the vortex tube 24, the inerting system has an inlet port 52, an NEA port 54, an OEA port 56 and a warming device 58 in the form of a heat exchanger. An inlet duct 62 extends between the inlet 26 of the vortex tube and the inlet port 52 of the inerting system 22, to allow the inlet 26 of the vortex tube 24 to receive the inlet air flow from the inlet port 52. A first NEA duct 60 extends between the NEA outlet 28 of the vortex tube 24 and the heat exchanger 58, and a second NEA duct 64 extends between the heat exchanger 58 and the NEA port 54. A first OEA duct 65 extends between the OEA outlet 30 and the heat exchanger 58, and a second OEA duct 56 extends between the heat exchanger 58 and the OEA port 56.

The first NEA duct 60, heat exchanger 58 and second NEA duct 64 co-operatively form an NEA duct arrangement 68 through which NEA exhausted from the NEA outlet 28 of the vortex tube 24 can flow to the NEA port 54 of the inerting system 22. Similarly, the first OEA duct 65, heat exchanger 58 and second OEA duct 66 co-operatively form an OEA duct arrangement 70 through which OEA exhausted from the OEA outlet 30 of the vortex tube 24 can flow to the OEA port 56 of the inerting system 22.

The heat exchanger 58 is configured to transfer heat from the OEA to the NEA without mixing the OEA and NEA, so as to warm the NEA as it passes from the NEA outlet 28 to the NEA port 54 and thereby form conditioned NEA (which can be supplied to the enclosures 14, 16, 18, 20 with less risk of other components freezing or ambient air condensing/freezing as discussed above).

The heat exchanger 58 has an inner pipe 72 positioned concentrically within an outer pipe 74, forming a double pipe heat exchanger. In use, NEA flows through the inner pipe 72, and OEA flows through the outer pipe 74 and entirely surrounds the NEA inside the heat exchanger 58. While the NEA and OEA pass through the heat exchanger 58, heat can pass from the OEA, through the wall of the inner pipe 72 and into the NEA. In the present embodiment, the heat exchanger 58 is a parallel-flow heat exchanger, with the NEA and OEA flowing generally parallel to one another as they pass through the heat exchanger 58.

It is noteworthy that in this embodiment the NEA duct arrangement 68 is configured to convey the NEA from the NEA outlet 28 of the vortex tube 24 to the NEA port 54 of the inerting system along a completely straight flow path. Flow losses in the NEA passing to the NEA port 54 are therefore relatively low. The OEA duct arrangement 70, on the other hand, is configured to convey the NEA along a flow path which has three 90 degree bends (all three between the OEA outlet 30 and the heat exchanger 58). Accordingly, flow losses in the OEA passing along the OEA duct arrangement 70 are somewhat higher.

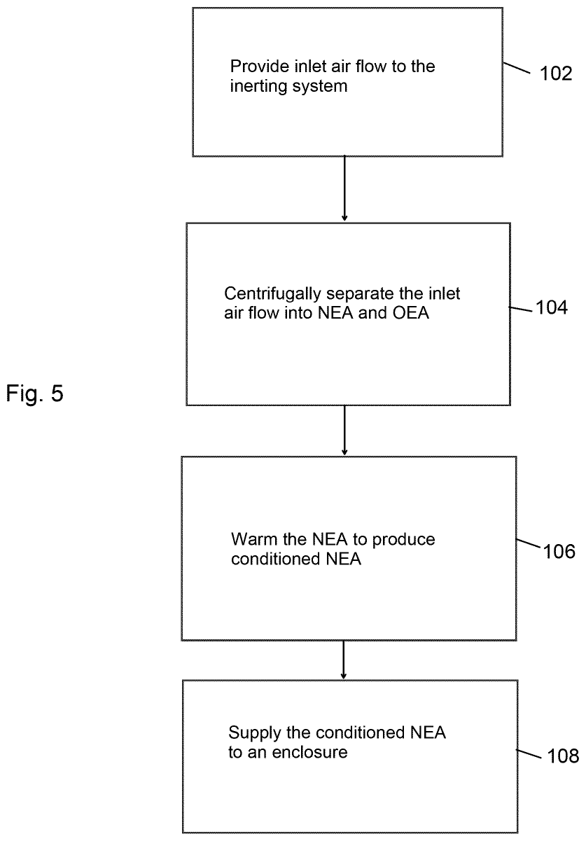

A method of use of the inerting system 22 of this embodiment will now be described with reference to FIG. 5 in combination with FIGS. 1 to 4.

To begin operation of the inerting system 22, the inlet air flow is provided 102 (from a ram air channel having already been compressed and cooled, as noted above) to the inerting system 22. The inlet air flow runs from the inlet port 52 of the inerting system 22, through the inlet duct 62 and into the vortex tube 24 through its inlet 26. The inlet air flow then passes through the plenum chamber 34, through the inlet passages 38 in the swirl generator 36 and into the vortex chamber 32.

In the vortex chamber 32, the inlet air flow is centrifugally separated 104 into NEA and OEA as described above. The NEA exits the vortex tube 24 through the NEA outlet 28 in the direction of the NEA outlet 28 (the “outlet direction”, to the left from the perspective of FIG. 4). It then passes along the first NEA duct 60 of the NEA duct arrangement 70 and enters the inner pipe 72 of the heat exchanger 58 while still moving in the outlet direction. The OEA exits the vortex tube 24 through the OEA outlet 30, passes along the first OEA duct 65 of the OEA duct arrangement 70 and enters the outer pipe 74 of the heat exchanger 58.

Once inside the heat exchanger 58, the NEA and OEA run in parallel directions to one another with the OEA completely surrounding the NEA around 360 degrees, with the NEA still flowing in the outlet direction. Heat passes into the NEA from the OEA, through the wall of the inner pipe 72 (which prevents the NEA and OEA from mixing), as the NEA continues to flow in the outlet direction. This warms 106 the NEA to produce conditioned NEA.

The conditioned NEA then exits the heat exchanger 58 and travels along the second NEA duct to the NEA port 56, still in the outlet direction, from where it is supplied 108 to one or more of the enclosures 14, 16, 18, 20 as needed. The OEA, which has been cooled by the transfer of heat into the NEA, exits the heat exchanger 58 and travels along the second OEA duct 66 to the OEA port 70. From there, it is exhausted overboard from the aircraft.

For the avoidance of doubt, FIG. 4 shows each of the above stages happening in sequence, as they would be experienced by a parcel of air travelling through the inerting system 22. However, each stage also takes place concurrently, with some air being separated while some already-separated NEA is being conditioned and other already-conditioned NEA is being supplied.

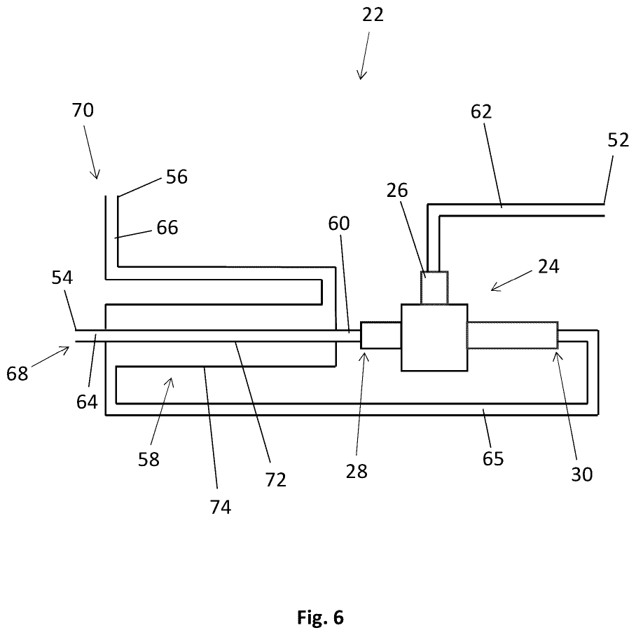

An enclosure inerting system of an aircraft according to a second embodiment of the invention will now be described with reference to FIG. 6 in combination with FIGS. 1 to 5. The second embodiment is similar to the first embodiment, therefore only the differences will be described. Corresponding features are denoted by corresponding reference numbers.

While in the first embodiment the heat exchanger 58 was a parallel-flow heat exchanger, in the second embodiment the heat exchanger 58 is a counter-flow heat exchanger. Within the heat exchanger 58, the OEA flows antiparallel to the NEA. While the heat exchanger 58 of the second embodiment can transfer more heat from the OEA to the NEA due to the fluids passing in antiparallel, it is to be noted that the flow path taken by the OEA is more complex. The OEA duct arrangement 70 has the same three 90 degree bends between the OEA outlet 30 and the heat exchanger 58 as is the case in the first embodiment, but also has two more downstream of the heat exchanger 58. The flow path for OEA is also considerably longer. The OEA flow therefore experiences significant flow losses.

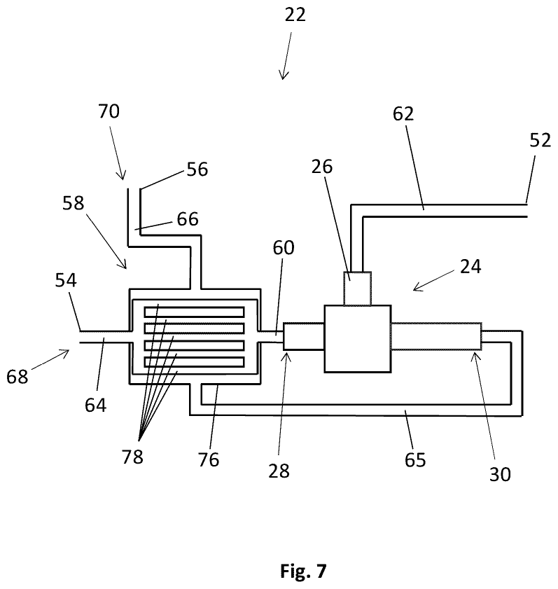

An enclosure inerting system of an aircraft according to a third embodiment of the invention will now be described with reference to FIG. 7 in combination with FIGS. 1 to 6. The third embodiment is similar to the first and second embodiments, therefore only the differences will be described. Corresponding features are denoted by corresponding reference numbers.

In the case of the third embodiment, the heat exchanger 58 is a shell and tube heat exchanger. The heat exchanger 58 has an outer shell 76 in the form of a pressure vessel, and a set of tubes 78 which run inside and across the outer shell 76. The NEA flows through the tubes 78 while the OEA flows through the shell 76. Accordingly, the NEA is still completely surrounded by the OEA while inside the heat exchanger 58.

The heat exchanger 58 of this embodiment is a cross-flow heat exchanger. In use, the NEA flowing through the tubes 78 and the OEA flowing through the shell 76 pass perpendicularly to one another. This heat exchanger 58 offers a moderate intermediate level of heat transfer from OEA to NEA, but allows the OEA duct arrangement 70 to be shorter than the second embodiment while having the same number of bends. The OEA therefore undergoes smaller flow losses than the second embodiment (but more than the first embodiment).

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents.

It will also be appreciated by the reader that integers or features of the invention that are described as preferable, advantageous, convenient or the like are optional and do not limit the scope of the independent claims. Moreover, it is to be understood that such optional integers or features, while of possible benefit in some embodiments of the invention, may not be desirable, and may therefore be absent, in other embodiments.

The term ‘or’ shall be interpreted as ‘and/or’ unless the context requires otherwise.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An inerting system configured to separate an inlet air flow into nitrogen enriched air (NEA) and oxygen enriched air (OEA), the inerting system having a vortex tube comprising:
an inlet configured to receive the inlet air flow from an inlet port of the inerting system;
a vortex chamber configured to receive the inlet air flow from the inlet and centrifugally separate it into the NEA and the OEA;
an NEA outlet configured to exhaust the NEA towards an NEA port of the inerting system; and
an OEA outlet configured to exhaust the OEA towards an OEA port of the inerting system,
wherein the inerting system further comprises a warming device configured to warm the NEA as it passes from the NEA outlet of the vortex tube to the NEA port of the inerting system.

2. The inerting system according to claim 1 wherein the warming device comprises a heat exchanger configured to transfer heat from the OEA to the NEA without mixing the OEA and NEA.

3. The inerting system according to claim 2 wherein within the heat exchanger, the OEA partially or substantially entirely surrounds the NEA.

4. The inerting system according to claim 2 wherein the heat exchanger is a shell and tube heat exchanger.

5. The inerting system according to claim 2 wherein the heat exchanger is a double pipe heat exchanger.

6. The inerting system according to claim 2 wherein the heat exchanger is a parallel-flow heat exchanger.

7. The inerting system according to claim 2 wherein the heat exchanger is a counter-flow heat exchanger.

8. The inerting system according to claim 2 wherein the heat exchanger is a cross-flow heat exchanger.

9. The inerting system according to claim 2, further comprising an NEA duct arrangement configured to convey the NEA from the NEA outlet of the vortex tube to the NEA port of the inerting system along a generally straight flow path.

10. The inerting system according to claim 2 wherein the inerting system comprises an aircraft enclosure inerting system.

11. An aircraft comprising an aircraft enclosure inerting system according to claim 10.

12. A method of supplying conditioned nitrogen enriched air (NEA) to an enclosure, the method comprising:
providing an inlet air flow to a vortex tube;
centrifugally separating the inlet air flow into NEA and oxygen enriched air (OEA) in the vortex tube;
warming the NEA to produce conditioned NEA; then
supplying the conditioned NEA to the enclosure.

13. The method according to claim 12 wherein the NEA is warmed by transferring heat from the OEA to the NEA without mixing them.

14. The method according to claim 13 wherein heat is transferred from the OEA to the NEA while the OEA partially or entirely surrounds the NEA.

15. The method according to claim 13 wherein heat is transferred from the OEA to the NEA by passing the OEA and NEA through a shell and tube heat exchanger.

16. The method according to claim 13 wherein heat is transferred from the OEA to the NEA by passing the OEA and NEA through a double-pipe heat exchanger.

17. The method according to claim 14 wherein the OEA and NEA pass in generally parallel directions while heat is being transferred from the OEA to the NEA.

18. The method according to claim 14 wherein the OEA and NEA pass in generally antiparallel directions while heat is being transferred from the OEA to the NEA.

19. The method according to claim 14 wherein the OEA and NEA pass generally transverse to one another while heat is being transferred from the OEA to the NEA.

20. The method according to claim 12 wherein the NEA exits the vortex tube in an outlet direction, and continues to flow generally in the outlet direction at least until it has been warmed.
